(19) United States
(12) Patent Application Publication
(10) Pub. No.: US 2014/0036069 A1
(43) Pub. Date: Feb. 6, 2014

(54) CAMERA SYSTEM AND METHOD FOR DETECTION OF FLOW OF OBJECTS

(71) Applicant: SICK AG, Waldkirch (DE)

(72) Inventors: Roland GEHRING, Waldkirch (DE); Jurgen REICHENBACH, Waldkirch (DE)

(21) Appl. No.: 13/918,153

(22) Filed: Jun. 14, 2013

(30) Foreign Application Priority Data
Jul. 31, 2012 (EP) 12178686.7

(51) Int. Cl. H04N 7/18

(52) U.S. Cl. CPC H04N 7/18
USPC 348/135

(57) ABSTRACT

A camera system (10) for the detection of a flow of objects (14) moving relative to the camera system (10) is provided, wherein the camera system (10) comprises a plurality of detection units (18a-b) which respectively have an image sensor for the recording of image data from a detection zone (18a-b) which partly overlap and together cover the width of the flow of objects (14) and comprising an evaluation unit (28) for the combination of image data from the detection units (18a-b) to a common image, as well as for the identification of regions of interest in the image data. In this connection the evaluation unit (28) is configured, on combination, to only use image data of the same detection unit (18a-b) within a region of interest for the common image.

The invention relates to a camera system and to a method for the detection of a flow of objects by means of a plurality of detection units in accordance with the preamble of claim 1 or claim 13 respectively.

For the automation of processes at a conveyor belt sensors are used in order to determine object properties of the conveyed objects and to initiate further processing steps in dependence thereof. In the logistic automation the processing typically comprises a sorting. Besides general information, such as volume and weight of the objects, frequently an optical code attached at the objects serves as the most important source of information.

The most used code readers are barcode scanners which scan a barcode i.e. a series of parallel bars forming a code, transverse to the code with a laser reading beam. They are frequently used at grocery store check outs, for automatic package identification, sorting of mail, or for the handling of luggage in airports and in other types of logistical operations. On the further development of digital camera technology, barcode scanners are increasingly being replaced by camera-based code readers. Instead of scanning code regions, a camera-based code reader records an image of the objects with codes present thereon with the aid of a pixel resolved image sensor and an image evaluation software extracts code information from these images. Camera-based code readers also come to term with other code types other than one-dimensional barcodes without a problem. The other code types being constructed like a matrix code and moreover being twodimensionally constructed and make available more information. In an important group of applications the objects carrying the codes are conveyed past the code reader. A camera, frequently a line camera reads the object images comprising the code information successively with respect to the relative movement.

An individual sensor is frequently not sufficient in order to record all relevant information about the objects on a conveyor belt. For this reason a plurality of sensors are combined in a reading system or a reading tunnel. If a plurality of conveyor belts lie next to one another for the increase of the object throughput or if an expanded conveyor belt is used then a plurality of sensors complement one another mutually at their too narrow viewing fields in order to cover the overall width. Moreover, sensors are mounted in different positions in order to record codes from all sides (omni reading).

The reading system makes available the detected information, such as code contents and images of the object, to a superordinate control. These images are, for example, used for an external text recognition, a visualization or a manual post processing (video coding). In this connection the reading system typically outputs an image per object. If a plurality of sensors are now arranged next to one another in order to cover a wider reading region then difficulties arise. Objects in an overlap region of the individual viewing fields are detected a plurality of times, other objects do not even lie within a single viewing field. Nevertheless, it is expected from the superordinate control that, independent of the reading width and the number of detecting sensors, respectively either exactly one complete image per object is output or object regions are completely included precisely once in an overall image of the flow of objects.

For this purpose different image processing methods are known in the literature which combine images from a plurality of sources (“image stitching”). In general, in the most demanding case in effort and cost, the image data is merely present and on combining the method attempts to reconstruct matching stitching positions from image features. Success and quality of the combination then strongly depends on the image data. Alternatively, the recording situation is precisely controlled, the cameras are thus aligned very precisely with respect to one another and calibrated such that the stitching points are known from the assembly. This is difficult to setup and very inflexible and deviations in the assumption on the assembly lead to a reduction in quality of the combined images. When especially the image quality in regions of interest, such as object regions, code regions or text fields, is detrimental, combined images possibly become useless due to the combination.

The EP 1 645 839 B1 discloses an apparatus for the monitoring of moved objects at a conveyor belt, which has an upstream distance measuring laser scanner for the detection of the geometry of the objects at the conveyor belt and a line camera. Due to the data of the laser scanner object regions are recognized as regions of interest (ROI) and the evaluation of the image data of the line camera is limited to these regions of interest. The combination of image data of code readers arranged next to one another is not provided in this connection.

The WO 03/044586 A1 discloses a method for the perspective rectification of images of an object at a conveyor which images are recorded with a line image sensor. For this purpose, each half of the image line is rescaled to a common image resolution by means of image processing, wherein each image line is processed in two halves. Also in this document a single line image sensor detects the overall width.

For this reason it is the object of the invention to improve the image quality on the combining of image data in a generic camera system.

This object is satisfied by a camera system and by a method for the detection of a flow of objects having a plurality of detection units in accordance with claim 1 or claim 13 respectively. In this connection the invention starts from the basic idea of keeping free important image regions from influences through the combination (stitching). For this purpose an evaluation unit determines regions of interest and within a region of interest only uses image data from a single source, namely of the same detection unit. The two functions, determining of regions of interest and stitching of image data, are in this respect in a manner of speaking combined in an evaluation unit. This should, however, by no means exclude the fact that two separate components can be used for this purpose in order to separate the functions both spatially and also in time. For example, the regions of interest can already be predefined by a geometry detection upstream of the camera system or on the other hand, the combination of image data can subsequently take place outside of the camera system.

Preferably, respective line sensors are used as image sensors in the detection unit whose image data is read in line-wise can be strung together in order to successively obtain an image during the relative movement of the object with respect to the camera system. The combination in the longitudinal direction or the movement direction is made very simple thereby. A later combination by image processing can respectively be limited to individual image lines. Through knowledge of the particular recording situation the general problem of the combining is significantly simplified in this manner. Alternatively, the detection units have matrix sensors or a few detection units are matrix sensors, others are line sensors.

The invention has the advantage that the common image can be combined in a simple manner. Only a very small loss in quality arises in the overlap region of the detection unit. Image data in the particularly relevant image regions, namely the regions of interest, are not changed by the combination. In this manner, the image quality remains high, particularly in the important regions, without image corrections demanding in effort and cost being required.

The evaluation unit is preferably configured to draw a connection line in the overlap region of two regions of interest of two detection units and on combination of the common image, to use image data of the one detection unit at the one side of the connection line and to use the image data of the other detection unit at the other side of the connection line. Thus a clear separation of image data of the respective sources along a stitch or a stitching line referred to as a connection line takes place and image data of the common image on this side and that side of the connection line respectively preferably stem exclusively from a detection unit. For example, the connection line is initially arranged centrally in the overlap region and subsequently indentations are formed in order to consider the regions of interest.

The evaluation unit is preferably configured to draw the connection line outside of the regions of interest. The connection line is thus so arranged or displaced in its position that regions of interest are avoided. In this manner, image data of the overall image reliably stems from only one source within regions of interest. A complete avoidance is always possible then when the width of the regions of interest corresponds to at most the width of the overlap region. Otherwise, it is attempted to draw the connection line such that the influence due to the unavoidable stitch within a region of interest remains small. For this purpose, for example, the connection line is so drawn that an as large as possible portion of the region of interest remains on one side, this means in particular the overall portion which lies within the overlap region. Alternatively, it can be attempted to leave the connection line and thus the stitch at least so within the region of interest that in particular critical image elements, such as code elements or letters, are respectively detected by image data of the same detection unit.

At least one detection unit is preferably configured as a camera-based code reader. Preferably, the overlap region is wider than a code. Thus, each detection unit can individually read the code and for this purpose the common image is not required. The common image then rather serves for the preparation of external detection methods such as text recognition (OCR) or for visualization, package tracking, error searching and the like. It is naturally still plausible to first decode the code from the common image. In this way, for example, an earlier decoding can then be checked due to the individual images of the detection units or an association of code contents, objects and other features can be comprehended or carried out.

Preferably the camera system has at least one geometry detection sensor in order to detect a contour of the flow of objects in advance. The contour corresponds to a distance map of the objects from the view of the camera system. For example, the geometry detection sensor is a distance measuring laser scanner or a 3D camera. The latter can principally also be configured integrated with the detection units. Then, the geometry data is not present in advance but is only available at the same time as the remaining image data. Although this can be too late for tasks, such as focus adjustment, all image data and geometry data required for the image processing on stitching of the common image is present, also for such an integrated solution.

The evaluation unit is preferably configured to determine regions of interest by means of the contour. Regions of interest are, for example, objects or suitable envelopes of objects, for example cuboids. Code regions or text fields cannot be detected by means of the pure geometry. For a simultaneous evaluation of the remission, however, also such regions are recognized, for example bright address fields.

The evaluation unit is preferably configured to consolidate regions of interest in an enveloping region of interest. As long as the detection units are in agreement on the position of regions of interest in an overlap region, the regions of interest can be detected by different detection units, but generally the same regions of interest can be identified with one another. However, when this is not the case, the regions of interest are in a manner of speaking stitched with an OR connection by an envelope. Since only one source, i.e. a detection unit, makes contributions from the image region of the envelope, the common image thus remains free from ambiguity and includes each region of interest precisely once.

The evaluation unit is preferably configured to output image data and additional information which permit a checking of the stitching or a subsequent stitching. Without the output of such additional information, including relevant parameters for the stitching of a common object, the stitching of a common image preferably takes place in the camera system and in real time. In a first alternative this also takes place in a an evaluation unit of the camera system, however, the individual images and the stitching information is also subsequently output in addition to the common image. A subsequent process checks whether the common image is stitched from the individual images in the desired manner. In a second alternative only the individual images and the additional information are output. However, a stitching to a common image does not take place within the camera system. A downstream process, possibly on a significantly more powerful system without real time requirements first uses the additional information in order to stitch the common image. In this way the three points in time for the recording of the individual image, the other individual image and the stitching of the individual image are decoupled from one another. It is also possible to change or newly determine the regions of interest in the subsequent process prior to the stitching within which regions of interest process image data of respectively only one detection is used for the common image.

The evaluation unit is preferably configured to output image data and additional information in a common structured file, in particular an XML file. In this way a subsequent process can very simply access all data. A standard format, such as XML, serves the purpose to even further simply the post processing, without having to have any knowledge on a proprietary data format.

The evaluation unit is preferably configured to output image data line-wise with additional information respectively being associated to a line. In this connection, the additional information has the format of an art stitching vector per image line.

When namely the image lines only have to be strung together in the movement direction of the objects the demanding part of the stitching of a common image is limited to the lateral direction. All relevant additional information for this purpose is stored line-wise in the stitching vector. For example, the latter stitching process initially reads the associated geometry parameters and recording parameters for each line in order to normalize (digital zoom) the object related resolution in the lines to be stitched in advance to a common predefined value.

The additional information preferably comprises at least one of the following pieces of information: content or position of a code, positions of regions of interest, object geometries or recording parameters. Thus, it can be taken from the additional information which part regions of the image data are important and how these part regions are arranged and oriented, such that also a subsequent process can take this into consideration on stitching and deteriorations of the image quality can be avoided. Recording parameters, such as focus, zoom, illumination time, camera position and orientation or perspective are further points of interest in addition to the image data themselves which points of interest simplify the stitching and improve the results.

The method in accordance with the invention can be furthered in a similar manner and in this connection shows similar advantages. Such advantageous features are described by way of example, but not conclusively, in the dependent claims adjoining the independent claims.

Preferably initially image date of the individual detection units and additional information are output and then the image data is subsequently combined to the common image by means of the additional information. Thereby limitations due to limited evaluation capacities of the camera system or real time requirements are omitted. The combining can also be limited to cases in which it is actually necessary, i.e., for example, in the case of reading errors, erroneous associations or investigations on the whereabouts of an object.

The regions of interest are preferably determined or redefined in a subsequent step once the objects have already been detected. The regions of interest are typically already determined by the camera system. However, this can also be omitted in accordance with this embodiment or the regions of interest delivered by the camera system are merely considered as a suggestion or even directly discarded. The subsequent step itself decides on the position of the regions of interest to be considered by redefinition or new definition. In this connection, subsequently in this example means, as was already previously the case, that the direct real time combining is rescinded, for example, an object has already been completely recorded. The plant as such can by any means also still be in operation during the subsequent step and can, for example detect further objects.

The detection units preferably individually track their recording parameters in order to achieve an ideal image quality, wherein the image data is subsequently normalized in order to simplify the combining. The individual tracking leads to improved individual images, however, precisely for unknown tracking parameters complicates the combining to a common image. For this reason, the camera system uses the knowledge on the tracking parameters preferably in order to carry out normalizations such as the rescaling to a same resolution in the object region (digital zoom), brightness normalization or smoothing. Following the normalization the individual differences are thus leveled out as far as possible by the detection units and the tracking parameters. In this manner, one could principally even balance out the use of differently designed detection units. Nevertheless, the detection units are preferably of like construction amongst one another in order to not pose any excessive requirements on the normalization and the image processing.

The invention will be described in detail in the following, also with respect to further features and advantages, by way of example by means of embodiments and with reference to the submitted drawing. The images of the drawing show:

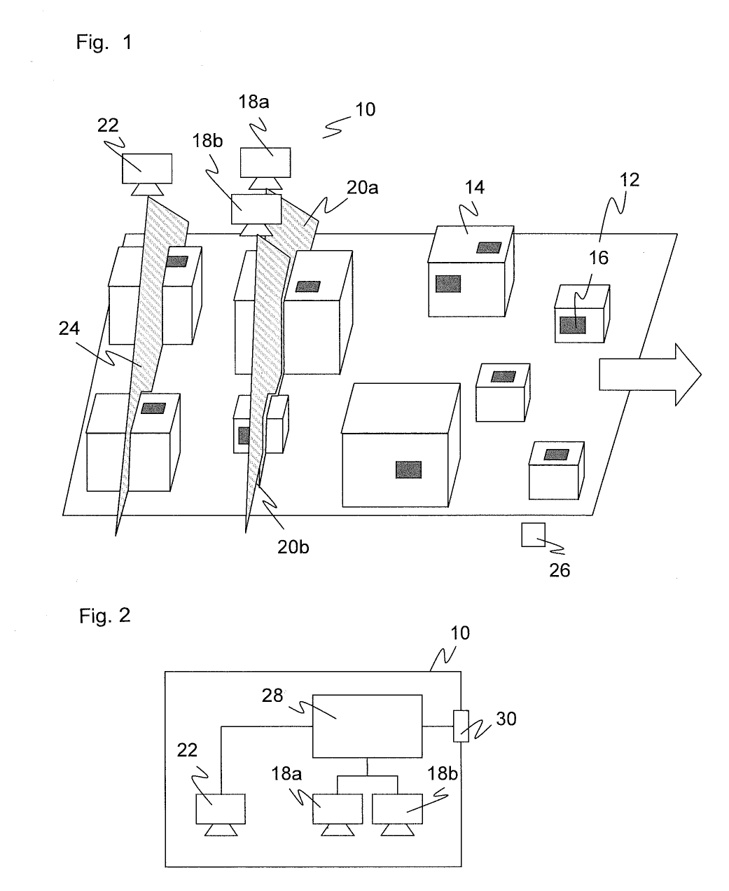

FIG. 1 a schematic three-dimensional top view on a camera system at a conveyor belt with objects to be detected;

FIG. 2 a very simplified block illustration of a camera system; and

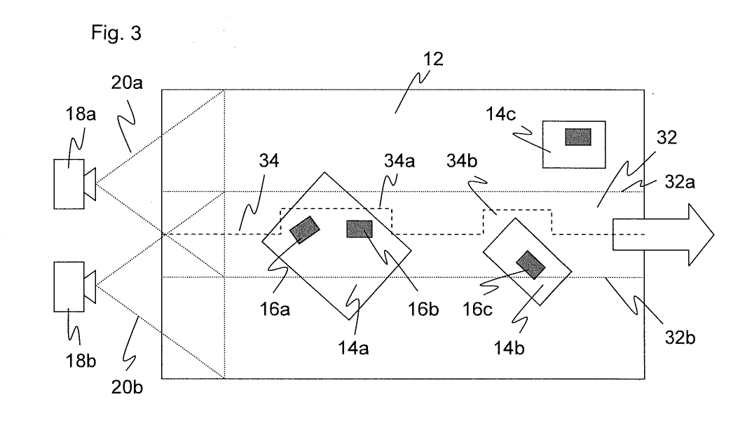

FIG. 3 a top view onto a conveyor belt with objects to be detected for the explanation of viewing fields, overlap regions and connection lines for two detection units of a camera system.

FIG. 1 shows a schematic three-dimensional top view onto a camera system 10 at a conveyor belt 12 with objects 14 to be detected on which codes 16 are attached.

The conveyor belt 12 is an example for the generation of a flow of objects 14 which move relative to the stationary camera system 10. Alternatively, the camera system 10 can be moved or the objects 14 move for a stationary mounting of the camera system 10, by a different means or by own movement.

The camera system 10 comprises two camera-based code readers 18a-b. They each have a non-illustrated image sensor having a plurality of light reception elements arranged to a pixel line or a pixel matrix, as well as a lens. The code readers 18a-6 are thus cameras which are additionally equipped with a decoding unit for the reading of code information and corresponding pre-processing for the finding and preparing of code regions. It is also plausible to detect flows of objects 14 without codes 16 and to correspondingly omit the decoder unit itself or its use. The code readers 18a-b can both be separate cameras, as well as the detection units within one and the same camera.

The conveyor belt 12 is too wide to be detected via an individual code reader 18ab. For this reason a plurality of detection zones 20a-b overlap in the transverse direction of the conveyor belt 12. The illustrated degree of overlap should be understood purely by way of example and can also significantly deviate in different embodiments. Moreover, additional code readers can be used whose detection zones can then pairwise overlap or overlap in larger groups. In the overlap regions the image data is available in a redundant manner. This is still to be used in a manner to be described in order to stitch a common image over the overall with of the conveyor belt 12.

In the example of FIG. 1, the regions of interest 20a-b of the code reader 18a-b are angular sections of a plane. At a point of time an image line of the objects 14 is thus detected at the conveyor belt 12 and during the movement of the conveyor belt, successive image lines are strung together in order to obtain a common image. When the image sensors of the code readers 18a-b are matrix sensors in deviation to this, the image can selectively be stitched from areal sections or selected lines of the matrix or snapshots are recorded and individually evaluated.

A geometry detection sensor 22, for example, in the form of a known distance measuring laser scanner is arranged above the code reader 18a-b with respect to the movement direction of the conveyor belt 12, which geometry detection sensor 22 covers the overall conveyor belt 12 with its detection zone. The geometry detection sensor 22 measures the three-dimensional contour of the objects 14 at the conveyor belt 12 so that the camera system 10 already knows the number of objects 14, as well as their positions and shapes and/or dimensions already before the detection process of the code reader 18a-b. The three-dimensional contour can subsequently still be simplified, for example, by a three-dimensional application of a tolerance field or by an enveloping of the objects 14 using simple bodies, such as cuboids (bounding box). With the aid of the geometry data of the three-dimensional contours, regions of interest are defined, for example, image regions with objects 14 or codes 16. In addition to the three-dimensional contour also remission properties can be measured in order to localize interesting features such as the objects 14, the codes 16 or others, for example, text or address fields. The regions of interest can very simply be stored and communicated via their basic points.

A laser scanner has a very large viewing angle so that also wide conveyor belts 12 can be detected. Nevertheless, additional geometry sensors can be arranged next to one another in a different embodiment in order to reduce shading effects by different object heights.

An encoder 26 can further be provided at the conveyor belt 12 for the determination of the feed motion and/or the speed. Alternatively, the conveyor belt moves reliably with a known movement profile or corresponding information is transferred to the camera system by a superordinate control. The respective feed rate of the conveyor belt 12 is required in order to combine the disc-wise measured geometries with the correct measure to a three-dimensional contour and to combine the image lines to a common image and in this manner to maintain the association beneath the detection position, albeit the constant movement of the conveyor belt 12, during the detection and up to the output of the detected object information and code information. The objects 14 are followed (tracked) for this purpose by means of the feed rate from their first detection. As described in the introduction, further non-illustrated sensors can be attached from different perspectives in order to detect geometries or codes from the side or from below.

FIG. 2 shows the camera system 10 in a very simplified block illustration. The three-dimensional contour determined by the geometry detection sensor 22 as well as the image data of the code reader 18a-b are transferred to a control and evaluation unit 28. There the different data is normalized in a common coordinate system. Regions of interest are determined, codes decoded and the image data is combined to a common image. Depending on the configuration code information and parameters, as well as image data are output in different processing steps via an output 30. The functions of the control and evaluation unit 28 can also be distributed in contrast to the illustration. For example, the geometry detection sensor 22 already determines the regions of interest, the code readers 18a-b already read out code information in own decoding units and the stitching of image data first takes place externally by a superordinate unit connected at the output 30 on the basis of output raw data. A different example is the splitting up of the code reader 18a-b into slave and master systems, wherein then the master system takes on the functions of the control and evaluation unit 28.

FIG. 3 shows the conveyor belt 12 again in the top view in order to explain the process on stitching of individual images of the code reader 18a-b to a common image. The detection zones 20a-b have an overlap region 32 which is limited in FIG. 3 by two dotted lines 32a-b. The overlap region 32 can dynamically depend on the three-dimensional contour data of the geometry detection sensor 22 and the position of the code reader 18a-b can be determined in the control and evaluation unit 28. Alternatively, the overlap regions 32 are configured. In the overlap region 32 a connection line 34 (stitching line) extends. For the common image data of the one code reader 18a above the connection line 34 is used, beneath the connection line image data of the other code reader 18b is used.

The connection line 34 in this manner forms a stitch in the common image. It is now desirable that this stitch remains as invisible as possible. This can be acted on by stitching algorithms demanding in effort and cost, previous matching and/or normalization of the respective individual images using the knowledge of recording parameters of the code reader 18a-b and post-processing of the overall image. All this is also additionally plausible in accordance with the invention. It should, however, initially be avoided that the stitch is given too large a significance in the common image by intelligent positioning of the connection line 34.

For this purpose it is provided that the connection line 34 is dynamically matched and in this connection is respectively drawn precisely such that regions of interests are avoided. In the example of FIG. 3 the connection line 34 forms an upwardly directed indentation 34a in order to avoid the code 16a-b. In the common image the codes 16a-b are exclusively formed from image data of the lower code reader 18b for this reason. Preferably, the connection line 34 maintains an even larger spacing to the regions of interest than illustrated in the event that the stitching algorithm considers a larger neighborhood in the vicinity of the stitching points. Through the stitching it is ensured by the consideration of regions of interest that their particularly relevant image information is not influenced.

If an object 14b completely lies within the viewing field of a single code reader 18b then this can be determined on the basis of the geometry data and the connection line 34 can be placed outside of the overall object 14b. This is illustrated in FIG. 3 by a second indentation 34b. The connection line 34 thus not only avoids the code 16c at this object 14b, but at the same time avoids the overall object 14b, in order to further reduce the influence of relevant image information. For the larger left object 14a which also projects into the exclusive viewing region 20a of the upper code reader 18a such a wide ranging avoidance of the connection line 34 is not possible such that in this example only the codes 16a-b have been considered. For the third illustrated object 14c nothing is to be done, since this object 14c is anyway only being detected by a code reader 14c and for this reason has nothing to do with the stitching point localized by the connection line 34.

In order to align the image sections corresponding to one another in the image data of the code readers 18a-b for the stitching of the common image to one another, the regions of interest, for example, provided by the edge points or edges of objects 14 or codes 16 in the common coordinate system can be used. In this connection only such points of the regions of interest are used as reference which are clearly identifiable in two images. By means of these overlapping reference positions the two images are placed on top of one another and are then taken over into the common image along the common connection line 34 respectively above the image data of the one image being taken from above the connection line 34 and the image data of the other image being taken from below the connection line 34. Naturally, also more demanding algorithms in effort and cost are plausible in which, for example, a neighborhood relationship of pixels for smooth transitions can be used. However, since the regions of interest themselves are precisely to be avoided by the connection line 34 these remain untouched by such stitching artifacts. Interferences lie outside, the image quality in the regions of interest itself remains maintained, since the image information in the original has been taken over by the corresponding code reader 18a-b and image corrections demanding in effort and cost can be omitted.

If different regions of interest are present in the two individual images then an enveloping common region of interest is formed from the individual regions of interest. The position of the connection line 34 then considers this enveloping region of interest.

The stitching of the common images can be different to that described so far and also take place decoupled from real time requirements in a subsequent process. For this purpose each code reader 18a-b or the control and evaluation unit 28 generates additional information which simplify the latter stitching. This additional information can in particular be written into a structured file, for example in the XML format. Besides the image data for the individual image of a code reader 18ab then, via the additional information, access, for example, to code information, code positions and object positions, positions of regions of interest, three-dimensional contours of objects, zoom factors of the respective image sections or positions and perspectives of code reader 18a-b preferably in the overall coordinate system are available. Also a fusion of the three-dimensional contour from the geometry detection sensor 22 with the image data of the code reader 18a-b as grey value texture is plausible.

Via the additional information a superordinate system connected at the output 30 knows all relevant data in order to comprehend the stitching of a common image for the purpose of control or to carry it out itself. In this connection also regions of interest and the connection line 34 can be newly determined and positioned.

Image data, in particular of the common image can be compressed for the output in order to reduce the required bandwidth. In this connection it is plausible to exempt the regions of interest from the compression in order to maintain their high image quality.

In the described embodiments the regions of interest are exempted from a stitching process in order to maintain their image information. In a complementary process it could be plausible to only limit the stitching to regions of interest. Thereby, the stitches lie within the regions of interest and in this way all the relevant information so that a worse image quality due to the stitching process cannot be excluded. For this purpose the demand is considerably reduced, since generally no common image has to be stitched outside of the regions of interest.

1. A camera system (10) for the detection of a flow of objects (14) moved relative to the camera system, the camera system (10) comprising a plurality of detection units (18a-b), said detection units respectively having an image sensor for the reception of image data from a detection zone (20a-b), said image data partially overlapping and said sensors together covering the width of the flow of objects (14), and the camera system further comprising an evaluation unit (28) for the combination of image data of the detection units (18a-b) to a common image as well as for the identification of regions of interest in the image data,
said evaluation unit (28) being configured to only use image data of the same detection unit (18a-b) within one region of interest for the common image on combining.

2. The camera system (10) in accordance with claim 1,
the evaluation unit (28) being configured to draw a connection line (34) in the overlap region of two detection zones (20a-b) of two detection units (18a-b) and, on combination of the common image, to use image data of the one detection unit (18a) at the one side of the connection line (34) and to use image data of the other detection unit (18b) at the other side of the connection line (34).

3. The camera system (10) in accordance with claim 2,
the evaluation unit (28) being configured to draw the connection line (34) outside of regions of interest.

4. The camera system (10) in accordance with claim 1,
said at least one detection unit (18a-b) being configured as a camera-based code reader.

5. The camera system (10) in accordance with claim 1,
the camera system (10) having at least one geometry detection sensor (22) in order to detect a contour of the flow of objects (14) in advance.

6. The camera system (10) in accordance with claim 5,
the evaluation unit (28) being configured to determine regions of interest by means of the contour.

7. The camera system (10) in accordance with claim 1,
the evaluation unit (28) being configured to consolidate regions of interest in an enveloping region of interest.

8. The camera system (10) in accordance with claim 1,
the evaluation unit (28) being configured to output image data and additional information which permits a checking of the combination or a subsequent combination.

9. The camera system (10) in accordance claim 8,
the evaluation unit (28) being configured to output image data and additional information in a common structured file.

10. The camera system (10) in accordance with claim 9, said structured file comprising an XML file.

11. The camera system (10) in accordance with claim 8,
the evaluation unit (28) being configured to output image data line-wise with additional information respectively associated to a line.

12. The camera system (10) in accordance with claim 8,
the additional information being selected from the group of members comprising at least one of the following pieces of information, content or position of a code (16), positions of regions of interest, object geometries and recording parameters.

13. A method for the detection of a flow of objects (14) by means of a plurality of detection units (18a-b), said detection units respectively recording image data of the objects (14) in a detection zone (20a-b), the detection zones (20a-b) partly overlapping and together cover the width of the flow of objects (14), said method comprising the steps of identifying regions of interest in the image data; combining image data of the detection units (18a-b) to a common image,
and on combination, only using image data of the same detection unit (18ab) for the common image within a region of interest.

14. The method in accordance with claim 13,
further comprising the steps of initially outputting image data of the individual detection units (18a-b) and additional information and then subsequently combining the image data to the common image by means of the additional information.

15. The method in accordance with claim 13,
further comprising the steps of determining the regions of interest in a subsequent step or redefining the regions of interest after the objects (14) have already been detected.

16. The method in accordance with claim 13,
in which the detection units (18a-b) individually track their recording parameters in order to achieve an ideal image quality and comprising the further step of subsequently normalizing the image data normalized in order to simplify the combination.
